(19) United States
(12) Patent Application Publication
(10) Pub. No.: US 2023/0074608 A1
(43) Pub. Date: Mar. 9, 2023

(54) TABLE SAW

(71) Applicant: Nanjing Chervon Industry Co., Ltd., Najing (CN)

(72) Inventors: Zhifeng Chen, Nanjing (CN); Dianbo Zhu, Nanjing (CN); Matthew Rybka, Nanjing (CN); Bun Hiong Chua, Nanjing (CN); Patrick Platteuw, Nanjing (CN)

(21) Appl. No.: 17/885,209

(22) Filed: Aug. 10, 2022

(30) Foreign Application Priority Data
Sep. 9, 2021 (CN) 202122174544.8

(51) Int. Cl. B23D 47/04; B23D 47/02

(52) U.S. Cl. CPC B23D 47/04; B23D 47/025

(57) ABSTRACT

A table saw includes a workbench, a support frame, a cutting assembly, a mounting device, and a first lighting mechanism. The workbench has a workplane. The support frame is used for supporting the workbench. The cutting assembly includes a cutting element, where the cutting element is disposed at least partially above the workplane, and a drive device that drives the cutting element to rotate around a rotational axis in a cutting plane. The mounting device is disposed above the cutting element. The first lighting mechanism is disposed on the mounting device and generates a first lighting region toward the cutting assembly.

### RELATED APPLICATION INFORMATION

This application claims the benefit under 35 U.S.C. § 119(a) of Chinese Patent Application No. CN 202122174544.8, filed on Sep. 9, 2021, which application is incorporated herein by reference in its entirety.

### BACKGROUND

A table saw is a table-top cutting device capable of cutting workpieces. The existing table saw is used in a wide range of environments, either indoors or outdoors. Whether indoors or outdoors, a light source of the table saw is mostly natural light or light far away from a cutting table. Therefore, in an outdoor environment with insufficient natural light or an indoor environment with poor light, the visual situation of the table saw is relatively poor, which seriously affects the use of a user, and the light far away from the cutting table is easy to form a shadow on the table saw, which is not conducive to the user’s use of the table saw.

### SUMMARY

A table saw includes a workbench, a support frame, a cutting assembly, a mounting device, a fence, a first lighting mechanism, and a second lighting mechanism. The workbench has a workplane. The support frame is used for supporting the workbench. The cutting assembly includes a cutting element and a drive device, where the cutting element is disposed at least partially above the workplane, and the drive device is configured to drive the cutting element to move to cut a workpiece. The mounting device is disposed at least partially above the cutting element. The fence is disposed on the workbench and used for abutting against the workpiece. The first lighting mechanism is used for generating illumination light and disposed on the mounting device. The second lighting mechanism is used for generating the illumination light and disposed on the fence.

In some examples, the cutting element is configured to be rotatable around a rotational axis in a cutting plane, where the cutting plane is perpendicular to the workbench; and a viewing window for a user to observe the cutting element from top to bottom is provided on the mounting device, where the viewing window is at least partially located on two sides of the cutting plane.

In some examples, the viewing window is disposed on an upper side of the cutting element.

In some examples, the mounting device has a first mounting surface facing the workbench, the first mounting surface includes a first region and a second region on two sides of the viewing window, and the first lighting mechanism is disposed in the first region or the second region.

In some examples, the cutting assembly includes a blade shield, where the blade shield includes shield members on two sides of the cutting element and the mounting device.

In some examples, the mounting device includes a support arm for supporting the mounting device to the table saw.

In some examples, a handle is provided on the mounting device and movable between a first position and a second position relative to the mounting device; where when the handle is at the first position, the mounting device is locked with the support arm, and when the handle is at the second position, the mounting device is separated from the support arm.

In some examples, a first switch is provided on the mounting device and used for controlling the first lighting mechanism to be turned on or off.

In some examples, the mounting device is in a form of a housing and disposed at least partially around the cutting element, a first mounting surface is formed on an inner side of the mounting device, and the first lighting mechanism is disposed on the first mounting surface.

In some examples, the first lighting mechanism is disposed above the cutting element.

In some examples, a second mounting surface facing the cutting assembly is formed on the fence, and the second lighting mechanism is mounted to the second mounting surface.

In some examples, the first lighting mechanism has a first lighting region, and the second lighting mechanism has a second lighting region, where the first lighting region at least partially overlaps with the second lighting region.

A table saw includes a workbench, a support frame, a cutting assembly, a fence, and a lighting mechanism. The workbench has a workplane. The support frame is used for supporting the workbench. The cutting assembly includes a cutting element and a drive device, where the cutting element is disposed at least partially above the workplane, and the drive device is configured to drive the cutting element to move to cut a workpiece. The fence is disposed on the workbench and used for abutting against the workpiece, where the fence has a mounting surface facing the cutting assembly. The lighting mechanism is disposed on the mounting device surface and emits light toward the cutting assembly.

A table saw includes a workbench, a support frame, a cutting assembly, a mounting device, and a first lighting mechanism. The workbench has a workplane. The support frame is used for supporting the workbench. The cutting assembly includes a cutting element and a drive device, where the cutting element is disposed at least partially above the workplane, and the drive device is configured to drive the cutting element to move to cut a workpiece. The mounting device is disposed at least partially above the cutting element. The first lighting mechanism is used for generating illumination light and disposed on the mounting device.

In some examples, the cutting element is configured to be rotatable around a rotational axis in a cutting plane, where the cutting plane is perpendicular to the workbench; and a viewing window for a user to observe the cutting element from top to bottom is provided on the mounting device, where the viewing window is at least partially located on two sides of the cutting plane.

In some examples, the viewing window is disposed on an upper side of the cutting element.

In some examples, the mounting device has a first mounting surface facing the workbench, the first mounting surface includes a first region and a second region on two sides of the viewing window, and the first lighting mechanism is disposed in the first region or the second region.

In some examples, a first switch is provided on the mounting device and used for controlling the first lighting mechanism to be turned on or off.

In some examples, the first lighting mechanism is disposed above the cutting element.

In some examples, the mounting device has a first mounting surface facing the workbench, the first mounting surface includes a first region and a second region, and the first lighting mechanism includes a first row of light-emitting diode (LED) lamps disposed in the first region and a second row of LED lamps disposed in the second region.

### BRIEF DESCRIPTION OF DRAWINGS

FIG. 1 is a perspective view of a table saw according to an example;

FIG. 2 is a perspective view of part of a structure of the table saw in FIG. 1;

FIG. 3 is a perspective view of a workbench, a cutting assembly, and a first lighting mechanism in FIG. 1;

FIG. 4 is a top view of FIG. 3;

FIG. 5 is a perspective view of part of a structure of a cutting assembly in FIG. 1 from a viewing angle;

FIG. 6 is a perspective view of part of a structure of a cutting assembly in FIG. 1 from another viewing angle;

FIG. 7 is a sectional view of a structure shown in FIG. 6;

FIG. 8 is a perspective view of a first region and a second region on a mounting device in FIG. 1;

FIG. 9 is a perspective view of part of a structure of a table saw according to another example; and

FIG. 10 is a perspective view of a mounting device in FIG. 9.

### DETAILED DESCRIPTION

Technical solutions of the present application will be described clearly and completely in conjunction with drawings. The examples described are part, not all, of the examples of the present application. Based on the examples of the present application, all other examples obtained by those of ordinary skill in the art without creative work are within the scope of the present application.

In the description of the present application, it is to be noted that orientations or position relations indicated by terms such as “center”, “upper”, “lower”, “left”, “right”, “vertical”, “horizontal”, “in”, and “out” are orientations or position relations based on the drawings. These orientations or position relations are intended only to facilitate the description of the present application and simplify the description, and not to indicate or imply that a device or element referred to must have such specific orientations or must be configured or operated in such specific orientations. Thus, these orientations or position relations are not to be construed as limiting the present application. In addition, terms such as “first” and “second” are used only for the purpose of description, and are not to be construed as indicating or implying relative importance. Terms “first position” and “second position” are two different positions.

In the description of the present application, it is to be noted that terms such as “mounted”, “joined”, and “connected” are to be understood in a broad sense unless otherwise expressly specified and limited. For example, the term “connected” may refer to “securely connected” or “detachably connected”; may refer to “mechanically connected” or “electrically connected”; or may refer to “connected directly”, “connected indirectly through an intermediary”, or “connected in two components”. For those of ordinary skill in the art, specific meanings of the preceding terms in the present application may be construed according to specific situations.

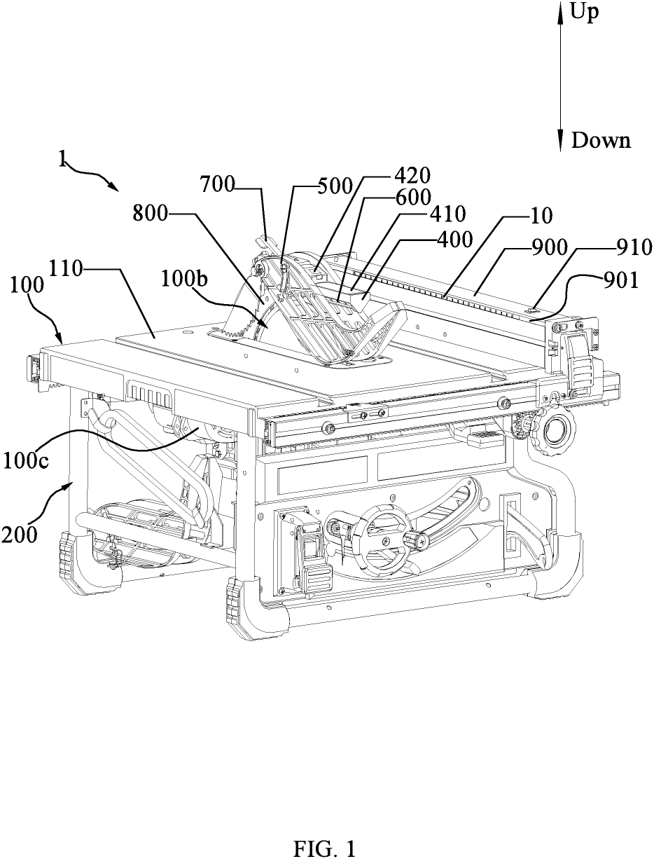

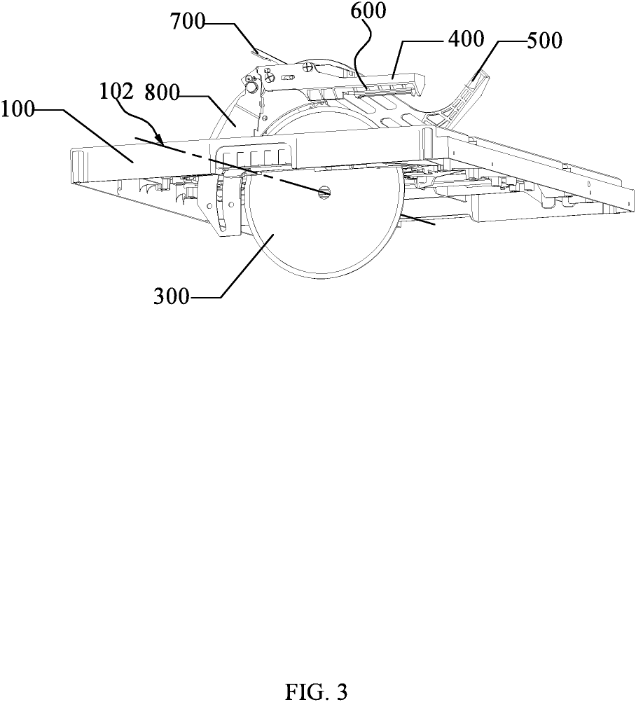

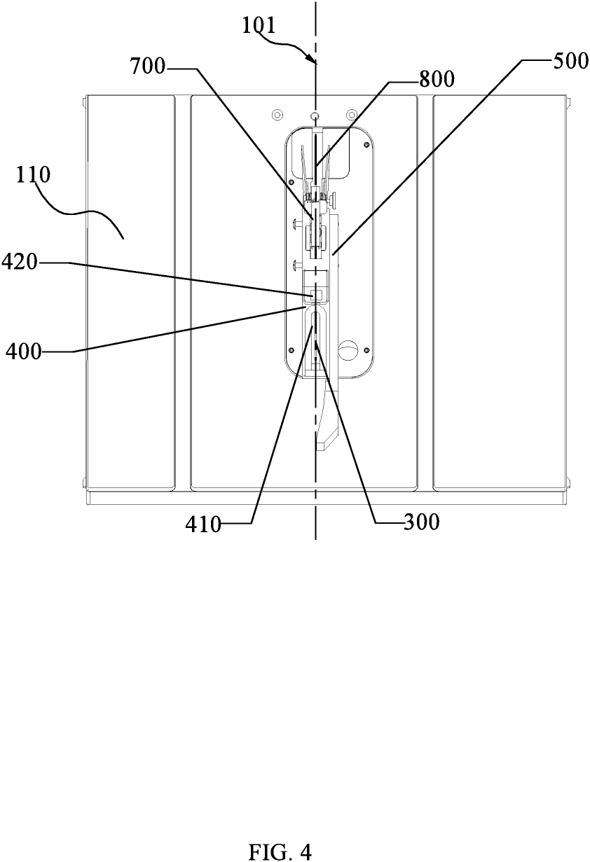

As shown in FIGS. 1 to 8, a table saw 1 includes a workbench 100, a support frame 200, a cutting assembly 100b, a mounting device 400, and a first lighting mechanism 600. The workbench 100 has a workplane 110, and a workpiece is placed on the workplane 110 so as to be cut completely. The support frame 200 is placed under the workbench 100 and used for supporting the workbench 100 so that the workbench 100 is located at a target height, so as to improve the comfort of a cutting worker when cutting the workpiece. The cutting assembly 100b includes a cutting element 300 and a drive device 100c, where the cutting element 300 penetrates through the workbench 100 so that the cutting element 300 is disposed at least partially above the workplane 110, and the drive device 100c drives the cutting element 300 to rotate around a rotational axis 102 in a cutting plane 101, thereby cutting the workpiece placed on the workplane 110. The mounting device 400 is disposed above the cutting element 300, and the first lighting mechanism 600 is disposed on the mounting device 400 and used for generating illumination light. The first lighting mechanism 600 is disposed toward the cutting assembly 100b, thereby generating a first lighting region on the cutting assembly 100b.

Compared with the existing table saw that uses natural light and light far away from the cutting assembly 100b as a light source, the table saw 1 provided in this example is provided with the first lighting mechanism 600 on the mounting device 400, and the first lighting mechanism 600 is used as an additional light source and can generate the first lighting region at the cutting assembly 100b, thereby improving the brightness at the cutting assembly 100b. Moreover, since the light source is close to the cutting element 300, a shadow generated at the cutting element 300 is relatively small, thereby providing the cutting element 300 with the best illumination. The illumination effect is not affected by a thickness of the workpiece and does not affect the user’s vision so that the user can easily observe a position relationship between a saw blade and a cutting surface of the workpiece, and when using the table saw 1, the user not only has a better field of vision and is not prone to safety accidents during a cutting operation, but also has relatively high cutting efficiency and cutting accuracy.

Specifically, the workbench 100 is a plate-like structure. Optionally, the workbench 100 is a rectangular plate, and a top surface of the rectangular plate is the workplane 110. A mounting through hole is provided in the middle of the workbench 100, and the cutting assembly 100b penetrates through the mounting through hole. Part of the cutting assembly 100b is above the workplane 110, and the remainder of the cutting assembly 100b is below the workplane 110. In this example, the mounting through hole is a rectangular hole.

The support frame 200 is a frame structure made of plates and rods. Optionally, the support frame 200 is a cubic frame structure. A top of the support frame 200 abuts against a bottom surface of the workbench 100, and a bottom of the support frame 200 is placed on the ground. To improve the structural strength of the support frame 200, structures such as reinforcing beams may be provided on the support frame 200. The support frame 200 is configured to be a frame structure so that an installation space is formed inside the support frame 200, and the cutting assembly 100b is partially placed in the installation space, thereby improving the structure compactness and installation convenience of the table saw 1.

The cutting element 300 includes a cutting saw blade, which is a circular saw blade in this example. The cutting saw blade penetrates through the mounting through hole on the workbench 100, and part of the cutting saw blade above the workplane 110 cuts the workpiece placed on the workplane 110. Optionally, the cutting saw blade is perpendicular to the workplane 110, that is, the cutting plane 101 of the cutting saw blade is perpendicular to the workbench 100, and the rotational axis 102 around which the cutting saw blade rotates is parallel to the workplane 110. The cutting element 300 arranged in such manner is often used for cutting the workpiece.

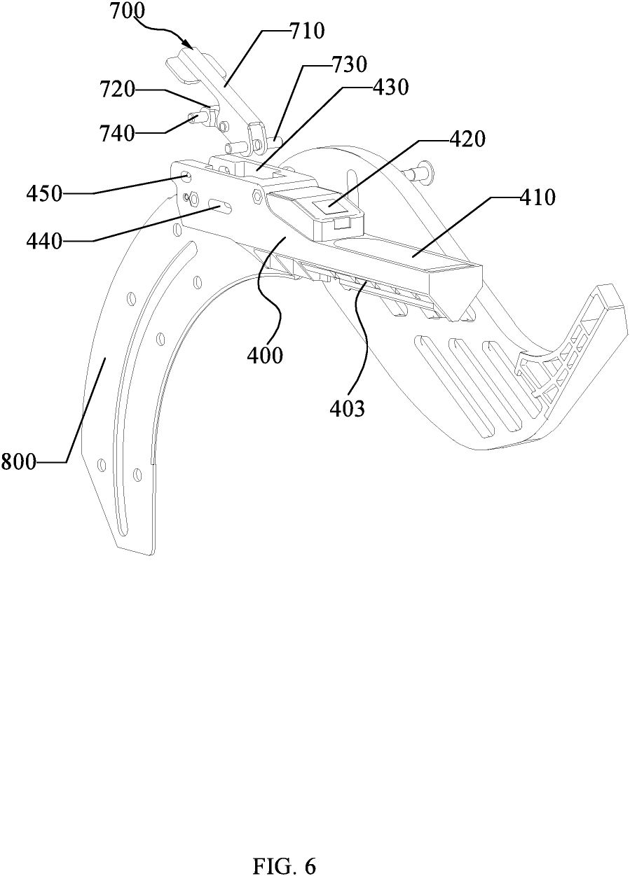

The mounting device 400 is arranged above the cutting saw blade, and in a vertical projection, the cutting element 300 is located in the middle of the mounting device 400, that is, projections of the saw blade and the mounting device 400 on the workplane 110 at least partially coincide, and the projection of the mounting device 400 is located at least partially outside the projection of the cutting saw blade. To position the mounting device 400 directly above the cutting saw blade, the cutting assembly 100b further includes a support arm 800 for supporting the mounting device 400 to the table saw 1. Specifically, as shown in FIGS. 6 to 8, the support arm 800 is an arc-shaped plate-like structure, and a rear end of the support arm 800 is detachably connected to the workbench 100 or the support frame 200 through a connecting piece. Compared with the rear end of the support arm 800, a front end of the support arm 800 is close to the mounting device 400 and detachably connected to the mounting device 400. The support arm 800 is configured to be an arc-shaped plate-like structure, which is not only beautiful, but also avoids the cutting saw blade. In other examples, the support arm 800 may also be configured to be an L-shaped plate-like structure.

Optionally, multiple mounting holes 810 are provided at the rear end of the support arm 800 at intervals along an extension direction of the rear end of the support arm 800. The connecting piece is connected to different mounting holes 810 so that the front end of the support arm 800 may be positioned at different heights, thereby positioning the mounting device 400 at different heights, which is conducive to improving the versatility of the table saw 1.

To achieve detachable connection between the front end of the support arm 800 and the mounting device 400, with continued reference to FIGS. 6 to 8, the cutting assembly 100b further includes a handle 700, and the handle 700 is between a first position and a second position relative to the mounting device 400. When the handle 700 is at the first position, the mounting device 400 is locked with the support arm 800, and when the handle 700 is at the second position, the mounting device 400 is separated from the support arm 800.

Specifically, as shown in FIG. 6, the handle 700 includes a main body connecting portion 710 and a rotation connecting portion 720. The main body connecting portion 710 includes top plates connected in a U shape, and side plates located on two sides of the two top plates. A first locking shaft 730 is provided at an end of the main body connecting portion 710 and penetrates through the two side plates. The rotation connecting portion 720 is an “I”-shaped block, and includes a first block, a connecting block and a second block connected in an “I” shape, and the first block is rotatably connected to the middle of the main body connecting portion 710. Specifically, rotating shafts protrude from two sides of the first block, respectively, and ends of the two rotating shafts are rotatably connected to middles of the two side plates, respectively, so as to achieve rotatable connection between the rotation connecting portion 720 and the main body connecting portion 710. One second locking shaft 740 protrudes from each of two ends of the second block.

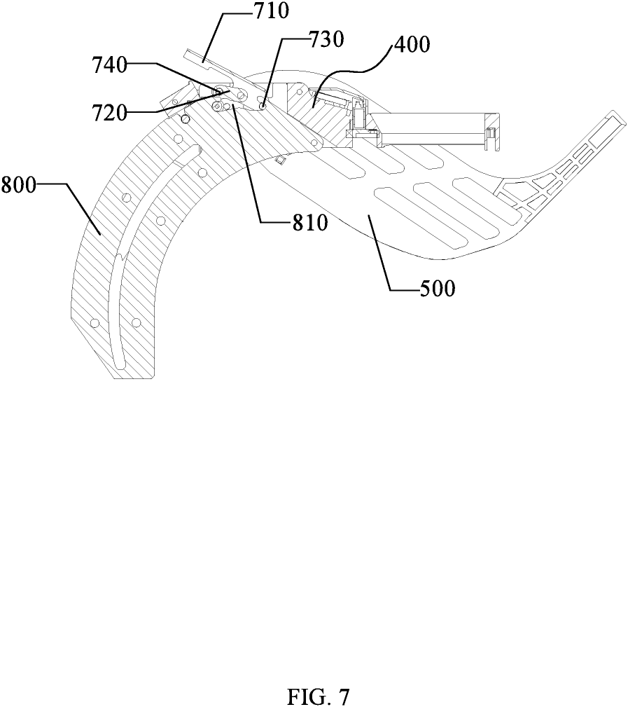

With continued reference to FIG. 6, a mounting slot 430 is provided at the rear of the mounting device 400, a first positioning hole 440 and a second positioning hole 450 are provided on each wall panel on each of two sides of the mounting slot 430, the two first positioning holes 440 are arranged opposite to each other and close to an inner side of the mounting slot 430, and the two second positioning holes 450 are arranged opposite to each other and close to an outer side of the mounting slot 430. As shown in FIG. 7, the front end of the support arm 800 is inserted into the mounting slot 430, a locking slot 810 is provided at the top of the part of the support arm 800 placed in the mounting slot 430, a front end of a bottom wall of the locking slot 810 is recessed forward to form a first locking position, and a rear end of the bottom wall is recessed backward to form a second locking position, that is, the first locking position and the second locking position are both arc-shaped slots. The first locking shaft 730 on a side of the main body connecting portion 710 sequentially passes through the first locking position and the first positioning hole 440 so that the mounting device 400 is rotatably connected to the support arm 800. At this time, the handle 700 is at the first position relative to the mounting device 400, and the mounting device 400 is separated from the support arm 800. When the mounting device 400 and the support arm 800 need to be engaged, the handle 700 is rotated counterclockwise. At this time, the second locking shaft 740 is snapped into the second locking position and the second positioning hole 450, and the handle 700 is at the second position relative to the mounting device 400. Optionally, an elastic member may be provided at the second locking shaft 740, thereby improving the smoothness of locking and unlocking of the mounting device 400 and the support arm 800.

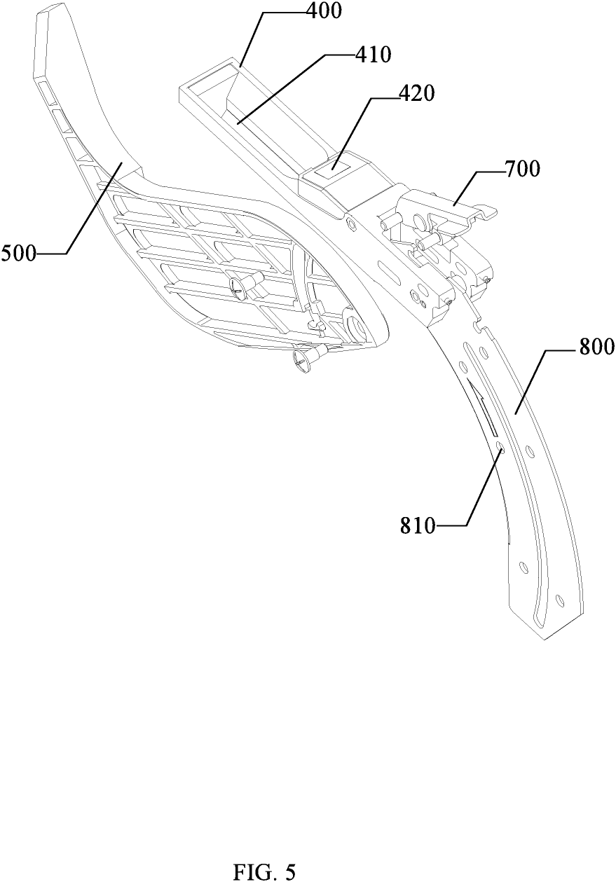

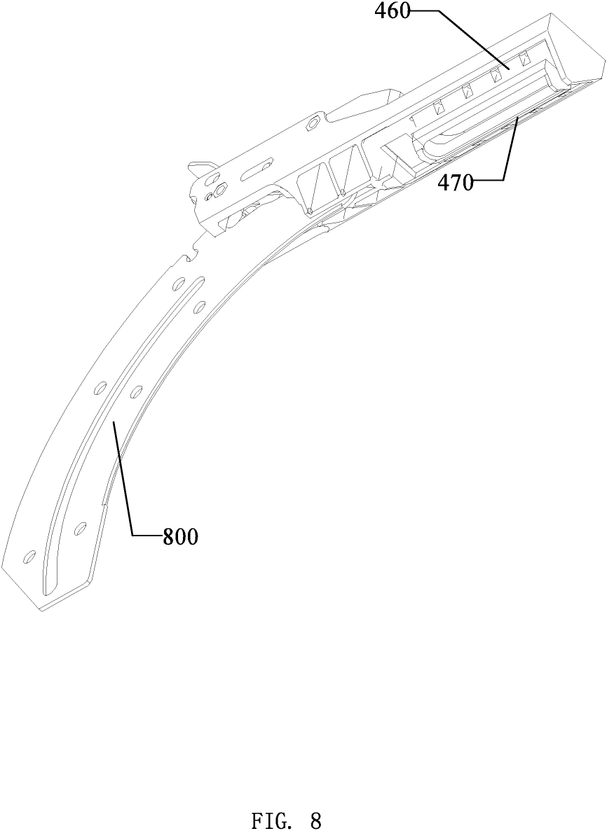

With continued reference to FIGS. 5 and 8, a viewing window 410 is provided at a front end of the mounting device 400 and at least partially located on two sides of the cutting plane 101 of the cutting saw blade, the mounting device 400 has a first mounting surface 403 facing the workbench 100, the first mounting surface 403 includes a first region 460 and a second region 470 on two sides of the viewing window 410, and the first lighting mechanism 600 is disposed in the first region 460 or the second region 470. In this manner, the first lighting mechanism 600 can illuminate the cutting saw blade from left and right sides of the cutting saw blade so that better visibility from two sides of the cutting saw blade is ensured. Optionally, the viewing window 410 is a rectangular through hole through which the cutting worker can observe a cutting condition of the cutting saw blade from top to bottom.

Further, the first lighting mechanism 600 is a light-emitting diode (LED) lamp, which saves power and has higher brightness. Specifically, a light bar or a light strip composed of multiple LED lamps may be selected. In this example, the light bar is selected, the multiple LED lamps constituting the light bar are arranged at intervals, and a projection direction of each LED lamp and the cutting saw blade form an included angle of 0 to 45 degrees. In this example, the LED lamps are embedded in the mounting device, and the first mounting surface 403 is provided with through holes for exposing the LED lamps. A first row of LED lamps is disposed in the first region, and a second row of LED lamps is disposed in the second region.

An accommodation cavity is provided in the middle of the mounting device 400, and a power supply is provided in the accommodation cavity and electrically connected to the first lighting mechanism 600 for supplying power to the first lighting mechanism 600. Optionally, the power supply is a battery, and specifically, a 3V to 6V button battery, and a cover body that can be opened and closed is provided at an opening of the accommodation cavity so that the battery may be easily detached and replaced. A first switch 420 is provided on the cover body and electrically connected to both the power supply and the first lighting mechanism 600, and the first switch 420 is used for controlling the first lighting mechanism 600 to be turned on or off. Optionally, the first switch 420 may also be arranged side by side with the cover, and the first switch 420 may be a push-button switch or a touch-type switch, and preferably, is a touch-type switch, which is not easily damaged. Optionally, a circuit board is further provided in the accommodation cavity and used for setting a display mode of the first lighting mechanism 600, for example, adjusting the brightness of the lamps, the color of the lamps, the number of turned-on lamps, and the like.

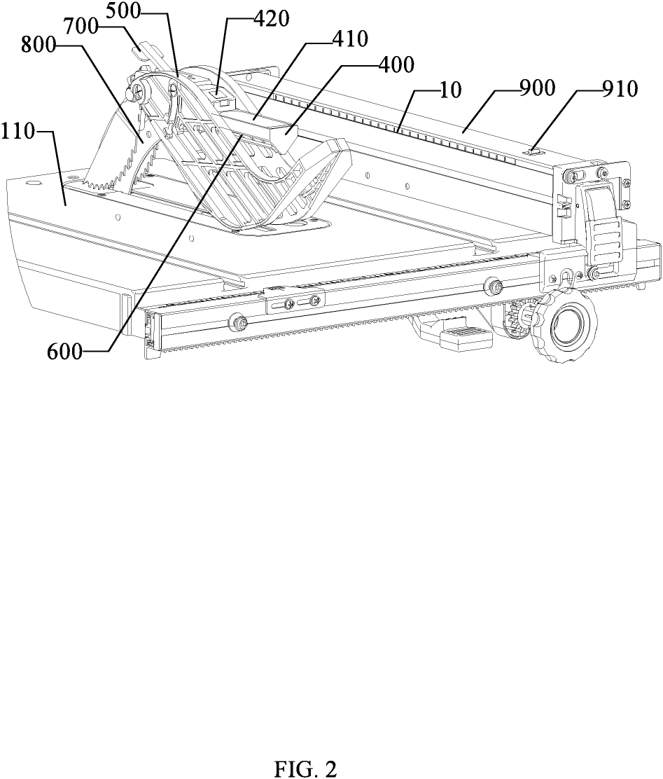

The cutting saw blade rotates at high speed when cutting a tool. The high-speed rotating cutting saw blade can be very dangerous. To improve the use safety of the table saw 1, with continued reference to FIGS. 1 and 2, the cutting assembly 100b of the table saw 1 further includes a blade shield 500, and the blade shield 500 includes shield members 501 on two sides of the cutting saw blade and the mounting device 400. The blade shield 500 can not only protect the hands of the cutting worker and prevent the hands from being too close to the cutting saw blade, but also can prevent debris generated during a cutting process from splashing out and hurting the cutting worker.

Optionally, the blade shield 500 is a protective grid plate, that is, the shield members 501 are grid structures made of multiple horizontal and vertical plates that intersect with each other horizontally and vertically. The grid structures can not only play a protective role, but also does not block the view of the cutting worker. The cutting worker can clearly see a condition of the workpiece cut by the cutting saw blade, thereby ensuring the cutting quality. Further optionally, the shield members 501 are in a shape of a hook as a whole, that is, each shield member 501 includes a first protection portion and a second protection portion connected in a hook shape, where a free end of the first protection portion is rotatably connected to a side of the mounting device 400, free ends of two second protection portions abut against each other and are located on a side of the cutting saw blade closer to the cutting worker, and a position where the first protection portion is connected to the second protection portion is in contact with the workplane 110 of the workbench 100.

As shown in FIG. 1, the table saw further includes a fence 900 and a second lighting mechanism 10. The fence 900 is disposed on the workplane 110 of the workbench 100 and used for abutting against the workpiece, thereby restricting a direction of movement of the workpiece when the cutting assembly 100b cuts the workpiece. The fence 900 has a second mounting surface 901 facing the cutting assembly 100b, and the second lighting mechanism 10 is disposed on the second mounting surface 901 and toward the cutting assembly 100b, thereby generating a second lighting region on the cutting assembly 100b.

Compared with the existing table saw that uses natural light and light far away from the cutting assembly as a light source, the table saw provided in this example is provided with the second lighting mechanism 10 on the fence 900, and the second lighting mechanism 10 is used as an additional light source and can generate the second lighting region at the cutting assembly 100b, thereby improving the brightness at the cutting assembly 100b. Moreover, since the light source is close to the cutting element, a shadow generated at the cutting element is relatively small. The second lighting mechanism 10 has a simple structure, is easy to be installed and replaced, and generates a wider second lighting region.

Specifically, the second lighting mechanism 10 is an LED lamp, such as a light bar or a light strip composed of multiple LED lamps. In this example, the light bar is selected, and the multiple LED lamps on the light bar are arranged at intervals along a length direction of the fence 900. From a front view, two ends of the LED light bar need to extend beyond two sides of the cutting saw blade, that is, a projection of the rotational axis of the cutting saw blade on the fence 900 is a center point, a point of the LED light bar facing the center point in a vertical direction is an origin, and a distance between the origin and each of two ends of the LED light bar needs to be greater than a radius of the cutting saw blade, so as to ensure that the entire saw blade is located in the second lighting region, thereby ensuring the illumination effect.

A cavity is provided inside the fence 900, and a power supply is provided in the cavity and electrically connected to the second lighting mechanism 10 for supplying power to the second lighting mechanism 10. Optionally, the power supply is a battery, for example, a rechargeable battery, and a universal serial bus (USB) charging port is provided on the fence 900 and used for charging the rechargeable battery. In addition to the rechargeable battery, a button battery may also be used, and a cover body that can be opened and closed is provided at an opening of the cavity so that the battery may be easily detached and replaced. A second switch 910 is provided on the cover body and electrically connected to both the power supply and the second lighting mechanism 10, and the second switch 910 is used for controlling the second lighting mechanism 10 to be turned on or off. Optionally, the second switch 910 may be a push-button switch or a touch-type switch, and preferably, a touch-type switch, which is not easily damaged.

The fence 900 is perpendicular to the workplane 110 of the workbench 100, the second lighting mechanism 10 has a height H relative to the workplane 110, and the cutting element has a height H₀ relative to the workplane, where H > 2/3Ho. Further optionally, an included angle between the second mounting surface 901 and the workplane 110 is greater than or equal to 45° and less than 90°, or greater than or equal to 80° and less than 90°. The preceding structure can ensure that the second lighting region is formed on the workbench 100 and can cover and mainly illuminate the cutting assembly 100b at the same time.

In this example, the first lighting region at least partially overlaps with the second lighting region. Preferably, an overlapping part of the first lighting region and the second lighting region can at least partially cover the cutting assembly 100b, thereby improving the illumination brightness while reducing a ghosting phenomenon. Since the second lighting mechanism 10 disposed on the fence 900 is easily affected by the thickness of the workpiece and may affect the user’s vision to a certain extent, the combination of the second lighting mechanism 10 and the first lighting mechanism 600 may make up for this shortcoming. Further, a position of the first lighting mechanism 600 is relatively fixed. During some workpiece cutting operations, the mounting device 400 needs to be removed, so the first lighting mechanism 600 cannot function. At this time, the second lighting mechanism 10 on the fence 900 is more flexible and can make up for the preceding defect of the first lighting mechanism 600.

Compared with the existing table saw 1 that uses natural light and light far away from the cutting assembly 100b as a light source, the table saw 1 provided in this example is provided with the first lighting mechanism 600 on the mounting device 400, the second lighting mechanism 10 is disposed on the fence 900, the first lighting mechanism 600 and the second lighting mechanism 10 are used as additional light sources and can generate the first lighting region and the second lighting region at the cutting assembly 100b, and the first lighting region at least partially overlaps with the second lighting region. In this manner, the brightness at the cutting assembly 100b is improved, and since the light sources are close to the cutting element, so a shadow generated at the cutting element is relatively small, and when using the table saw 1, the user not only has a better field of vision and is not prone to safety accidents during a cutting operation, but also has relatively high cutting efficiency and cutting accuracy.

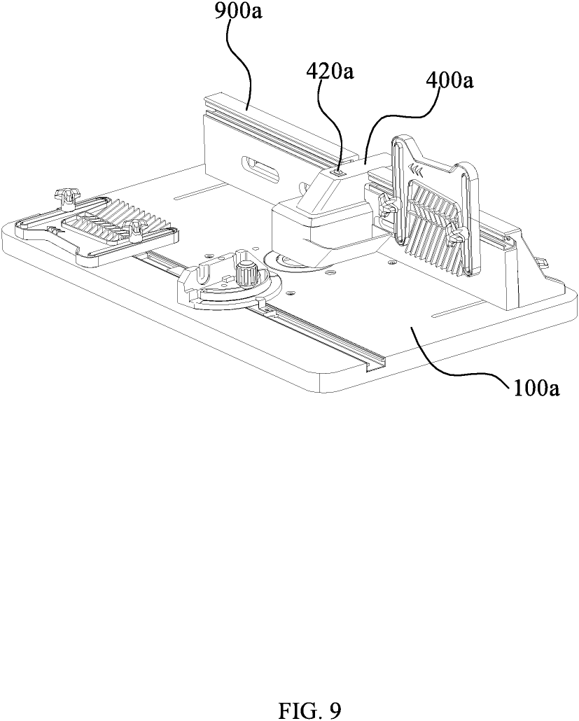

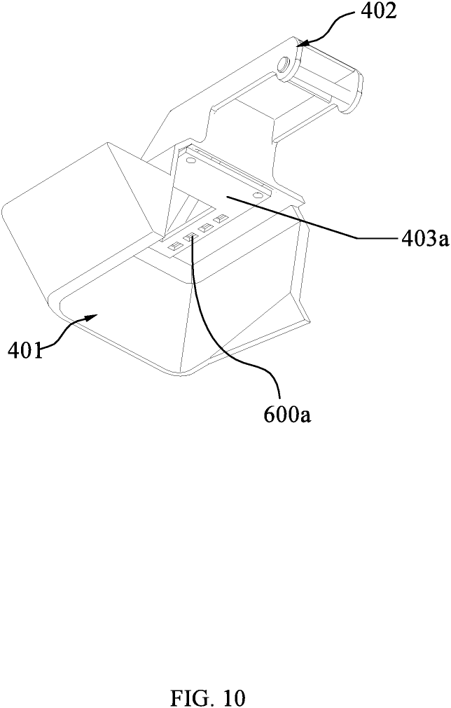

This example provides another table saw. As shown in FIGS. 9 and 10, the table saw includes a workbench 100a, a support frame, a cutting assembly, a mounting device 400a, and a first lighting mechanism 600a. The workbench 100a and the support frame are no different from the workbench 100 and the support frame 200 in the table saw 1, which are not be repeated here, and only the mounting device 400a, the first lighting mechanism 600a and the cutting assembly are described in detail below.

Specifically, the cutting assembly includes a cutting element, the cutting element is specifically a cutting saw blade, and a drive device drives the cutting saw blade to rotate around a rotational axis in a cutting plane, where the rotational axis is perpendicular to the workbench 100a, and the cutting plane is parallel to a workplane of the workbench 100a.

In this example, multiple blades are arranged so as to form the cutting element. Compared with the circular saw blade in example one, which rotates in a vertical plane to cut off the workpiece, a bar-shaped saw blade in this example rotates in a horizontal plane, thereby cutting a groove-like structure into the workpiece.

The mounting device 400a is a shell-like structure and disposed at least partially around the cutting element; the rotational axis is perpendicular to the workbench 100a; a first mounting surface 403a is formed on an inner side of the mounting device 400a, and the first lighting mechanism 600a is disposed on the first mounting surface 403a.

Specifically, the mounting device 400a includes an accommodation portion 401 and a connecting arm 402. The accommodation portion 401 includes a rectangular top wall panel and side wall panels that are folded down and extend along three sides of the rectangular top wall panel so that a side opening and a bottom opening are formed on the accommodation portion 401. An inner wall surface of the top wall panel and inner wall surfaces of the three side wall panels enclose to form an accommodation cavity, a first switch 420a is disposed on an outer wall surface of the top wall panel, and the cutting element is placed in the accommodation cavity. The inner wall surface of the top wall panel is the first mounting surface 403a, and the first lighting mechanism 600a is disposed on the inner wall surface of the top wall panel and used for generating a first lighting region on the cutting assembly. The connecting arm 402 is an L-shaped structure, where an end of the connecting arm 402 is fixedly connected to the outer wall surface of the top wall panel, and the other end of the connecting arm 402 is rotatably connected to the workbench 100a, so as to achieve rotatable connection between the mounting device 400a and the workbench 100a. In this manner, it is convenient to switch the mounting device 400a between a working state of covering the cutting saw blade and a non-working state of avoiding the cutting saw blade.

The mounting device 400a is configured to be a shell-like structure so that the mounting device 400a can be used as a shield while the first lighting mechanism 600a is fixed on the mounting device 400a, the structure is compact, and the manufacturing cost is reduced.

In this example, the table saw may further include a fence 900a on the workbench 100a, where the fence 900a may also be provided with a lighting mechanism having substantially the same structure as the second lighting mechanism 10 in the table saw 1.

The preceding examples of the present application are merely illustrative examples of the present application and are not intended to limit implementations of the present application. For those of ordinary skill in the art, changes or alterations in other different forms may also be made based on the preceding description. All implementations cannot be and do not need to be exhausted herein. Any modifications, equivalent substitutions, and improvements made within the spirit and principle of the present application fall within the scope of the claims of the present application.

What is claimed is:

1. A table saw, comprising:
a workbench with a workplane;
a support frame for supporting the workbench;
a cutting assembly comprising a cutting element and a drive device, wherein the cutting element is disposed at least partially above the workplane and the drive device is configured to drive the cutting element to move to cut a workpiece;
a mounting device disposed at least partially above the cutting element;
a fence disposed on the workbench and used for abutting against the workpiece;
a first lighting mechanism for generating illumination light and disposed on the mounting device; and
a second lighting mechanism for generating the illumination light and disposed on the fence.

2. The table saw of claim 1, wherein the cutting element is configured to be rotatable around a rotational axis in a cutting plane, the cutting plane is perpendicular to the workbench, a viewing window for a user to observe the cutting element from top to bottom is provided on the mounting device, the viewing window is at least partially located on one side of the cutting plane, and the viewing window is at least partially located on the other side of the cutting plane.

3. The table saw of claim 2, wherein the viewing window is disposed on an upper side of the cutting element.

4. The table saw of claim 3, wherein the mounting device has a first mounting surface facing the workbench, the first mounting surface comprises a first region disposed on one side of the viewing window and a second region disposed on the other side of the viewing window, and the first lighting mechanism is disposed in the first region or the second region.

5. The table saw of claim 1, wherein the cutting assembly comprises a blade shield, and the blade shield comprises shield members on two sides of the cutting element and the mounting device.

6. The table saw of claim 1, wherein the mounting device comprises a support arm for connecting the mounting device to the table saw.

7. The table saw of claim 6, wherein a handle is provided on the mounting device and movable between a first position and a second position relative to the mounting device, the mounting device is locked with the support arm when the handle is at the first position, and the mounting device is separated from the support arm when the handle is at the second position.

8. The table saw of claim 1, wherein a first switch is provided on the mounting device and used for controlling the first lighting mechanism to be turned on or off.

9. The table saw of claim 1, wherein the mounting device is in a form of a housing and disposed at least partially around the cutting element, a first mounting surface is formed on an inner side of the mounting device, and the first lighting mechanism is disposed on the first mounting surface.

10. The table saw of claim 1, wherein the first lighting mechanism is disposed above the cutting element.

11. The table saw of claim 1, wherein a second mounting surface facing the cutting assembly is formed on the fence and the second lighting mechanism is mounted to the second mounting surface.

12. The table saw of claim 1, wherein the first lighting mechanism has a first lighting region, the second lighting mechanism has a second lighting region, and the first lighting region at least partially overlaps with the second lighting region.

13. A table saw, comprising:
a workbench comprising a workplane;
a support frame for supporting the workbench;
a cutting assembly comprising a cutting element and a drive device, wherein the cutting element is disposed at least partially above the workplane, and the drive device is configured to drive the cutting element to move to cut a workpiece;
a fence disposed on the workbench and used for abutting against the workpiece, wherein the fence has a mounting surface facing the cutting assembly; and
a lighting mechanism disposed on the mounting surface and emitting light toward the cutting assembly.

14. A table saw, comprising:
a workbench comprising a workplane;
a support frame for supporting the workbench;
a cutting assembly comprising a cutting element and a drive device, wherein the cutting element is disposed at least partially above the workplane, and the drive device is configured to drive the cutting element to move to cut a workpiece;
a mounting device disposed at least partially above the cutting element; and
a first lighting mechanism for generating illumination light and disposed on the mounting device.

15. The table saw of claim 14, wherein the cutting element is configured to be rotatable around a rotational axis in a cutting plane, the cutting plane is perpendicular to the workbench, a viewing window for a user to observe the cutting element from top to bottom is provided on the mounting device, and the viewing window is at least partially located on two sides of the cutting plane.

16. The table saw of claim 15, wherein the viewing window is disposed on an upper side of the cutting element.

17. The table saw of claim 16, wherein the mounting device has a first mounting surface facing the workbench, the first mounting surface comprises a first region and a second region on two sides of the viewing window respectively, and the first lighting mechanism is disposed in the first region or the second region.

18. The table saw of claim 14, wherein a first switch is provided on the mounting device and used for controlling the first lighting mechanism to be turned on or off.

19. The table saw of claim 14, wherein the first lighting mechanism is disposed above the cutting element.

20. The table saw of claim 14, wherein the mounting device has a first mounting surface facing the workbench, the first mounting surface comprises a first region and a second region, and the first lighting mechanism comprises a first row of LED lamps disposed in the first region, and a second row of LED lamps disposed in the second region.
